(19) United States
(12) Patent Application Publication
(10) Pub. No.: US 2020/0254571 A1
(43) Pub. Date: Aug. 13, 2020

(54) CURVED PANEL AND METHOD OF FORMING THE SAME

(71) Applicant: Georgia-Pacific Corrugated LLC, Atlanta, GA (US)

(72) Inventors: Chester Denny Lee Garner, Richmond, IN (US); David Kent Balser, Cambridge City, IN (US)

(21) Appl. No.: 16/863,314

(22) Filed: Apr. 30, 2020

Related U.S. Application Data
(63) Continuation-in-part of application No. 15/952,750, filed on Apr. 13, 2018.

(51) Int. Cl. B23K 26/38; B32B 29/08; B32B 3/28; B65D 65/40; B65D 5/02

(52) U.S. Cl. CPC B23K 26/38; B32B 29/08; B32B 3/28; B23K 2103/30; B65D 5/0209; B65D 5/0254; B65D 65/403

(57) ABSTRACT

A method of forming a board into a curved panel, including: providing a cutting tool having a support portion and a cutting portion, the cutting portion having a first cutting edge, and a plurality of second cutting edges disposed adjacent each other and recessed relative to the first cutting edge by a defined offset dimension; placing a corrugated board on the support portion such that a b-facing-layer is disposed facing the support portion, and an a-facing-layer is disposed facing the cutting portion; advancing the cutting portion toward the board such that the first cutting edge cuts completely through both the a-facing-layer and the b-facing-layer of the board, and the plurality of second cutting edges cut completely through the a-facing-layer, but not completely through the b-facing-layer; and, retracting the cutting portion away from the support portion and removing the panel to facilitate further manipulation of the panel into the curved panel.

### CROSS REFERENCE TO RELATED APPLICATIONS

This application is a continuation-in-part application of U.S. application Ser. No. 15/952,750 filed Apr. 13, 2018, which is hereby incorporated by reference in its entirety.

### BACKGROUND OF THE INVENTION

The present disclosure relates generally to a panel, and particularly to a curved panel and a method of forming the same.

Packing containers and panels thereof are often formed from a corrugated sheet product material that is cut with a die to form one or more flat blanks, or scored and slotted to form a flat blank. The flat blank is folded into a three-dimensional container that may be secured using an arrangement of flaps, adhesive liquids, staples or adhesive tapes.

A form of a packing container made from a corrugated sheet product material includes a container having corners that are created by scoring and folding to create a squared off corners. Such containers are efficiently stackable on a pallet with little or no space between adjacently stacked containers. While existing packing containers may be suitable for their intended purpose, the art relating to packing containers made from corrugated sheet product material would be advanced with the inclusion of one or more radiused corners with a smooth outer arc for a more aesthetic appearance.

This background information is provided to reveal information believed by the applicant to be of possible relevance to the present invention. No admission is necessarily intended, nor should be construed, that any of the preceding information constitutes prior art against the present invention.

### BRIEF DESCRIPTION OF THE INVENTION

An embodiment includes a method of forming a board into a curved panel by strategically cutting the board to strategically weaken it, the board including a corrugated board having a first facing layer, a second facing layer, and a corrugated material adhesively joined to and disposed between the first and second facing layers, the method including: providing a cutting tool having a support portion and a cutting portion, the cutting portion having at least one cutting edge configured to provide at least one first cutting edge, and a plurality of second cutting edges disposed adjacent each other, each edge of the plurality of second cutting edges being recessed relative to an edge of the at least one first cutting edge by a defined offset dimension; placing the board on the support portion such that b-layer that is one of the first facing layer or the second facing layer is disposed facing the support portion, and an a-layer that is the other one of the first facing layer or the second facing layer is disposed facing the cutting portion; moving the cutting portion toward the support portion with the board disposed therebetween; advancing the cutting portion toward the board such that the at least one first cutting edge cuts completely through both the a-layer and the b-layer of the board, and the plurality of second cutting edges cut completely through the a-layer, but not completely through the b-layer, resulting in the board being an edge cut panel with through cuts in the a-layer and the b-layer at the at least one first cutting edge, and with through cuts in the a-layer but not the b-layer at the plurality of second cutting edges; and, retracting the cutting portion away from the support portion and removing the panel to facilitate further manipulation of the panel into the curved panel via the through cuts in the a-layer but not the b-layer resulting from cuts at the plurality of second cut edges.

The above features and advantages and other features and advantages of the invention are readily apparent from the following detailed description of the invention when taken in connection with the accompanying drawings.

### BRIEF DESCRIPTION OF THE DRAWINGS

Referring to the exemplary non-limiting drawings wherein like elements are numbered alike in the accompanying Figures:

FIG. 1 depicts a rotated perspective view of a container, in accordance with an embodiment;

FIG. 2 depicts a plan view of an inner facing side of a flat blank suitable for forming the container of FIG. 1, in accordance with an embodiment;

FIG. 3 depicts a plan view of an outer facing side of the flat blank of FIG. 2, in accordance with an embodiment;

FIG. 4 depicts a section view along cut line 4-4 depicted in FIG. 3, in accordance with an embodiment;

FIG. 5 depicts a plan view of a portion of an alternative inner facing side of a flat blank suitable for forming the container of FIG. 1, in accordance with an embodiment;

FIG. 6 depicts a plan view of a portion of another alternative inner facing side of a flat blank suitable for forming the container of FIG. 1, in accordance with an embodiment;

FIG. 7 depicts a plan view of a portion of the inner facing side of a flat blank similar to that of FIG. 2, in accordance with an embodiment;

FIG. 8 depicts a plan view of a portion of yet another alternative inner facing side of a flat blank suitable for forming the container of FIG. 1, in accordance with an embodiment;

FIG. 9 depicts a plan view of a portion of a further alternative inner facing side of a flat blank suitable for forming the container of FIG. 1, in accordance with an embodiment;

FIG. 10 depicts a plan view of a portion of yet a further alternative inner facing side of a flat blank suitable for forming the container of FIG. 1, in accordance with an embodiment;

FIG. 11 depicts a block diagram front elevation cross section view of a cutting tool, such as a flatbed cutting tool for example, useful for fabricating a curved panel, in accordance with an embodiment; and

FIG. 12 depicts a flowchart of a method of forming a board into a curved panel, in accordance with an embodiment.

### DETAILED DESCRIPTION OF THE INVENTION

Although the following detailed description contains many specifics for the purposes of illustration, anyone of ordinary skill in the art will appreciate that many variations and alterations to the following details are within the scope of the claims appended hereto. Accordingly, the following example embodiments are set forth without any loss of generality to, and without imposing limitations upon, the claimed invention disclosed herein.

An embodiment, as shown and described by the various figures and accompanying text, provides a flat blank of a corrugated sheet product material and a container formed from the flat blank, where the container has at least one curved panel that forms a corner of the container having a smooth outer arced surface, where the curved panel is created by a plurality of side by side cuts or scores on an inner facing of the corrugated sheet product material, and where the cuts or scores do not extend through the outer facing of the corrugated sheet product material. As used herein, the phrase side by side cuts or scores is intended to encompass cuts or scores that are linear, or cuts or scores that are shaped lines formed by a series of side by side curves, curls, s-shapes, or other shapes, where the shaped lines still produce the desired smooth outer arced surface as disclosed herein.

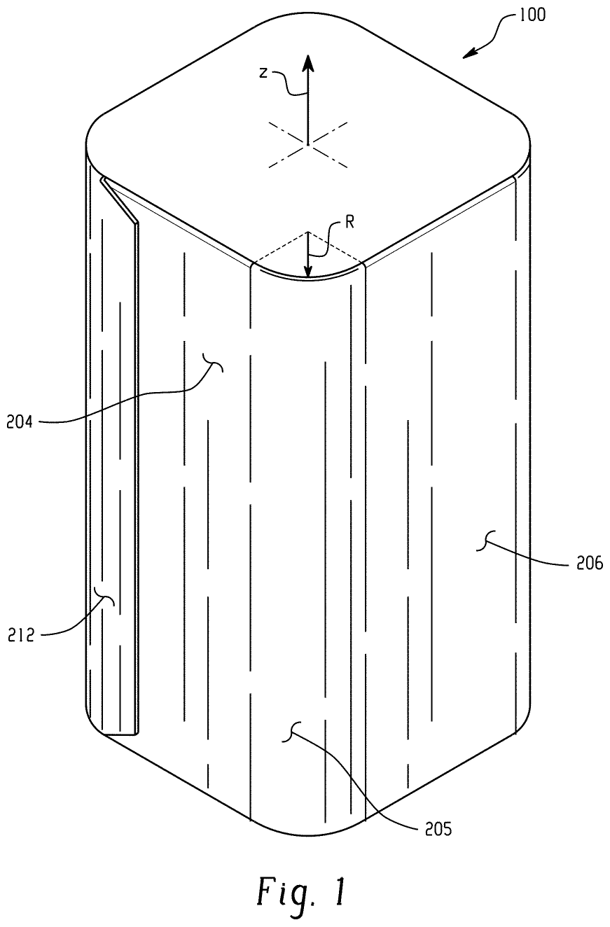

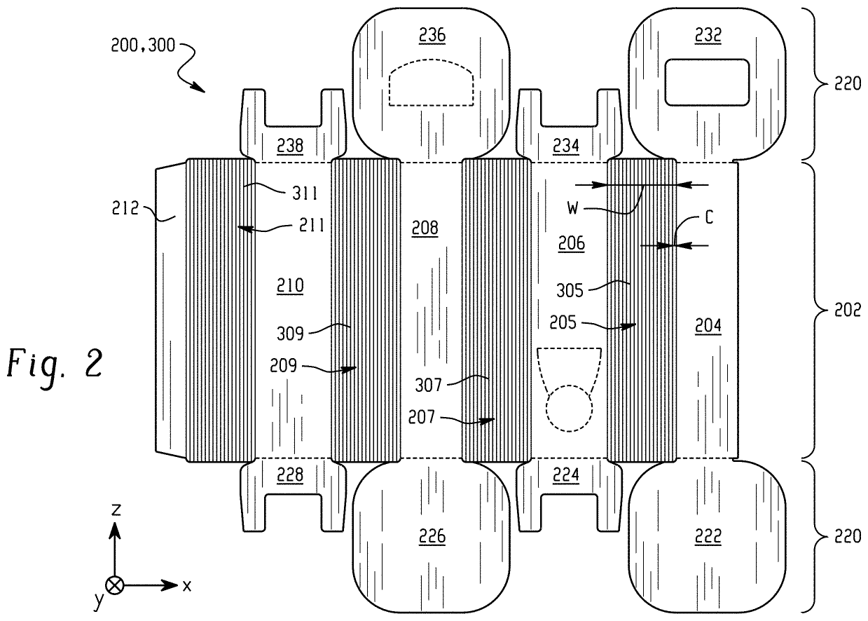

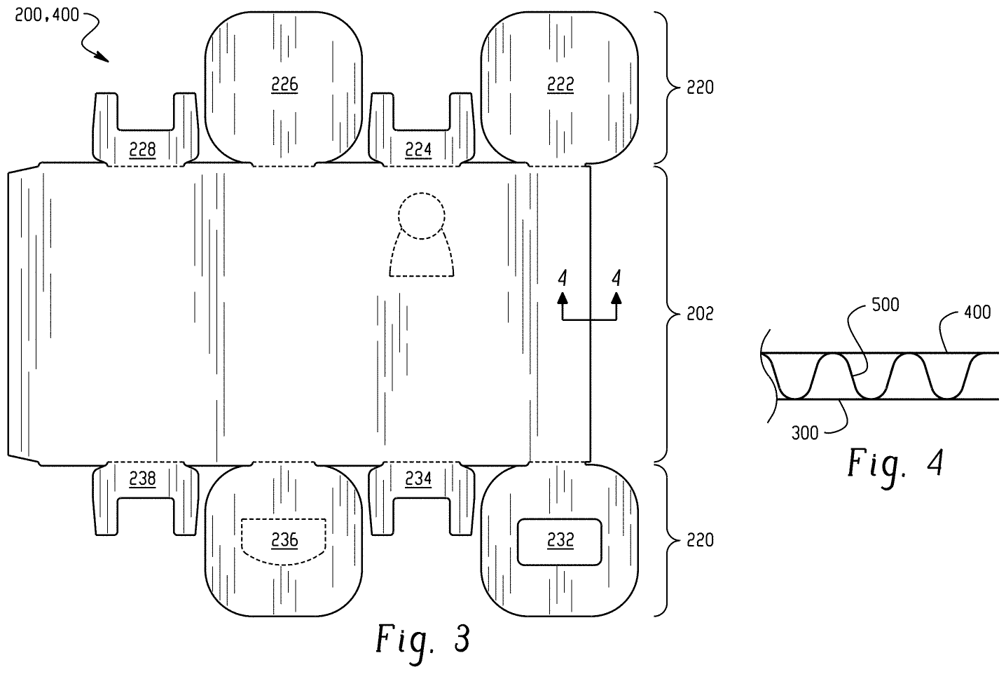

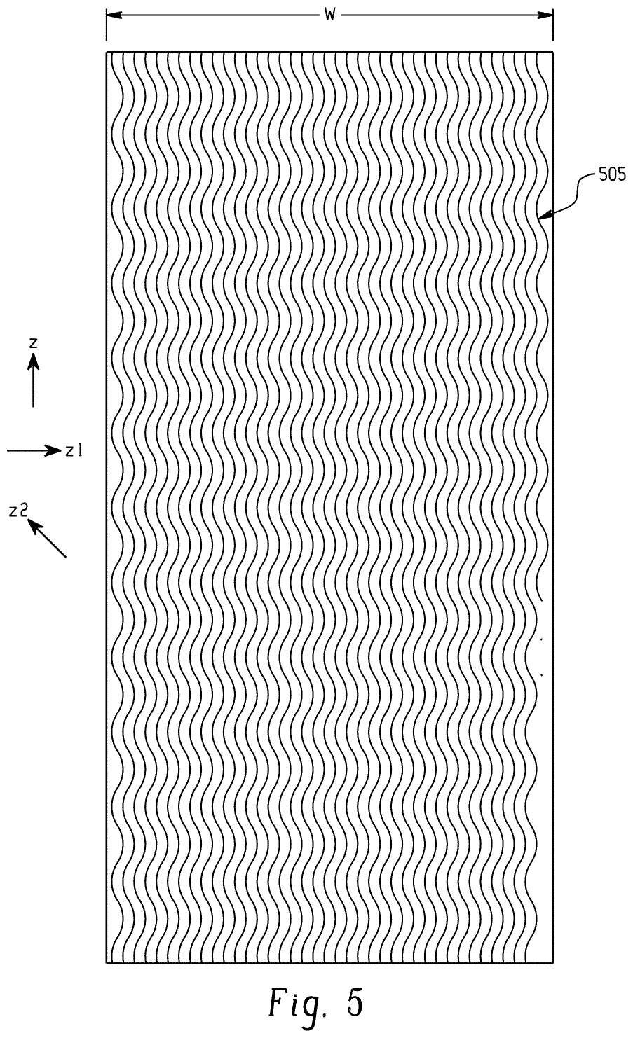

Reference is now made to FIGS. 1-4 collectively, where FIG. 1 depicts a rotated perspective view of a container 100 in accordance with an embodiment, FIG. 2 depicts one side, the inner side and inner facing, of a flat blank 200 suitable for forming the container 100, where features particular to the inner side, inner facing, are referred to by reference numerals 300+, FIG. 3 depicts another side, outer side and outer facing, of the flat blank 200, where features particular to the outer side, outer facing, are referred to by reference numerals 400+, and FIG. 4 depicts a section view along cut line 4-4 depicted in FIG. 3. General features of the flat blank 200 are herein referred to by reference numerals 200+.

In an embodiment, the container 100 includes a plurality of panels 202 integrally arranged with respect to each other via a plurality of fold lines (depicted as dashed lines in FIGS. 2 and 3), score lines (depicted as solid lines in FIGS. 2 and 3), or perforated lines, or any combination of fold, score, or perforated lines, and with respect to a set of orthogonal x, y and z axes, the plurality of panels 202 being formed from a corrugated sheet product material and being foldable to create the container 100. The plurality of panels 202 include a plurality of planar panels 204, 206, 208, 210, 212, and at least one curved panel 205, 207, 209, 211, where an axis of radius of the at least one curved panel is disposed parallel to the z-axis. As depicted in FIG. 4, corrugated sheet product material, and particularly the corrugated sheet product material disclosed herein, has an inner facing 300, an outer facing 400, and a corrugated material 500 between the inner and outer facings. With respect to the container 100 disclosed herein, the corrugated material of the curved panels 205, 207, 209, 211 has flutes oriented parallel with the z axis. Further with respect to the curved panels 205, 207, 209, 211, the inner facing 300 includes a plurality of linear cuts 305, 307, 309, 311 arranged in sets and disposed parallel with each other and parallel with the flutes, where each set of the plurality of linear cuts pierce at least partially through the inner facing 300 but not through the outer facing 400. In an embodiment, the plurality of linear cuts pierce completely through the inner facing 300. In another embodiment, the plurality of linear cuts are replaced with a plurality of linear scores of sufficient depth so as to produce the desired smooth outer arced surface as disclosed herein. In a further embodiment, the plurality of linear cuts are a combination of linear cuts and linear scores that produce the desired smooth outer arced surface as disclosed herein. As depicted in FIG. 2, the four sets of the plurality of planar panels 204, 206, 208, 210, and the four sets of the curved panels 205, 207, 209, 211, are disposed in an alternating arrangement with respect to each other.

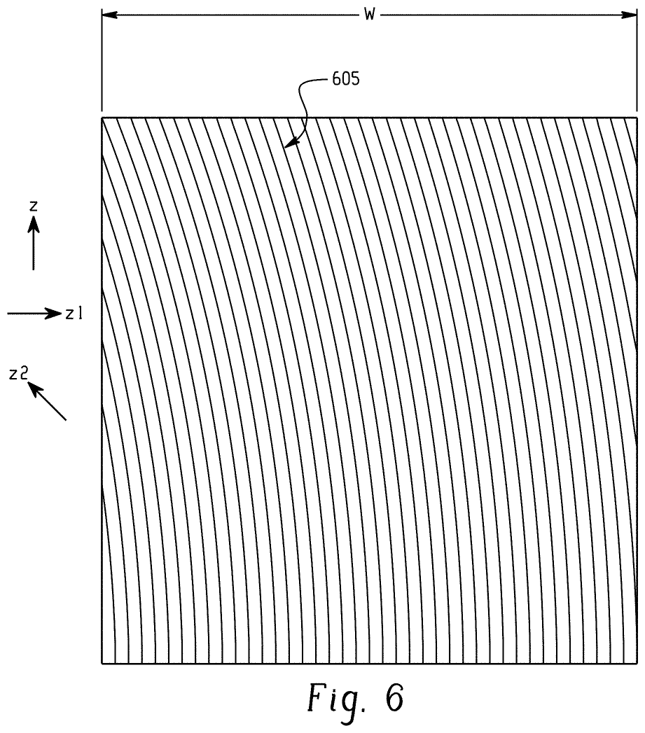

While the embodiment of FIG. 2 depicts the cuts 305, 307, 309, 311 as a plurality of linear cuts, it has been found that the plurality of cuts may in fact not be linear (e.g., a straight line), but may be composed of a plurality of side by side cuts or scores that are not necessarily linear, which are described herein below with reference to FIGS. 5-10. As such, any reference herein to a plurality of linear cuts is also a reference to a plurality of side by side cuts or scores that are not necessarily linear, consistent with a disclosure herein.

In an embodiment, each cut of each set of the plurality of linear cuts 305, 307, 309, 311 are disposed at a distance equal to or less than 0.2 inches and equal or greater than 0.01 inches with respect to each other in the corresponding set, or even closer at a distance equal to or less than 0.13 inches with respect to each other in the corresponding set, see dimension C in FIG. 2 for example. In an embodiment, each cut of each set of the plurality of linear cuts 305, 307, 309, 311 are disposed not necessarily in registration with the flutes. Stated alternatively, a subset of the linear cuts may be disposed out of registration with the flutes, while another subset of the linear cuts may be disposed in registration with the flutes. In an embodiment, each set of the plurality of linear cuts 305, 307, 309, 311 have an overall width W, and the curved panels have a radius of curvature R equal to about 2*W/π. As used herein, the term “equal to about” means “equal to, within acceptable tolerances and accounting for the bending characteristics of the material used”.

As depicted in FIG. 2, an embodiment of the container 100 further includes a plurality of planar side panels that are collectively referred to by reference numeral 220, and individually referred to by reference numerals 222, 224, 226, 228, 232, 234, 236, 238, where a pair of the plurality of planar side panels are contiguous with a corresponding one of the plurality of planar panels, see for example: side panel pairs 222, 232 and planar panel 204; side panel pairs 224, 234 and planar panel 206; side panel pairs 226, 236 and planar panel 208; and, side panel pairs 228, 238 and planar panel 210.

As depicted in the various figures provided herewith, an embodiment of the container 100 includes an arrangement where the plurality of planar panels 204, 206, 208, 210 consists of at least four planar panels with a fifth planar panel 212 being used as an adhesion panel that is adhered to planar panel 204 in the folded and assembled state, and where the at least one curved panel consists of at least two, or alternatively four, of the at least one curved panel, see panels 205, 207, 209, 211, for example.

In accordance with an embodiment, a flat blank 200 is disclosed herein having a plurality of panels 202, 220 integrally arranged with respect to each other with a plurality of fold lines (depicted as dashed lines in FIGS. 2 and 3), score lines (depicted as solid lines in FIGS. 2 and 3), or perforated lines, or any combination of fold, score, or perforated lines, disposed therebetween, the plurality of panels being foldable to form the container 100. In connection with the description of the container 100 herein above, the plurality of planar panels include a first plurality of panels 204, 206, 208, 210, and a second plurality of panels 205, 207, 209, 211, the first plurality of panels being foldable to form the plurality of planar panels 204, 206, 208, 210, and the second plurality of panels being foldable to form the curved panels 205, 207, 209, 211. Other structural features of the flat blank 200 as disclosed herein are consistent with the description of the container 100 herein above that is formed from the flat blank 200. With respect to FIGS. 2 and 3, it will be noted that the plurality of linear cuts 305, 307, 309, 311 are present on the inner facing 300 only as depicted in FIG. 2, but not the outer facing 400 as depicted in FIG. 3, which provides the desired degree of formability of the flat blank 200 to form the container 100 with smooth arced outer corners. In an embodiment, the flat blank 200 is formed around a mandrel to form the container 100.

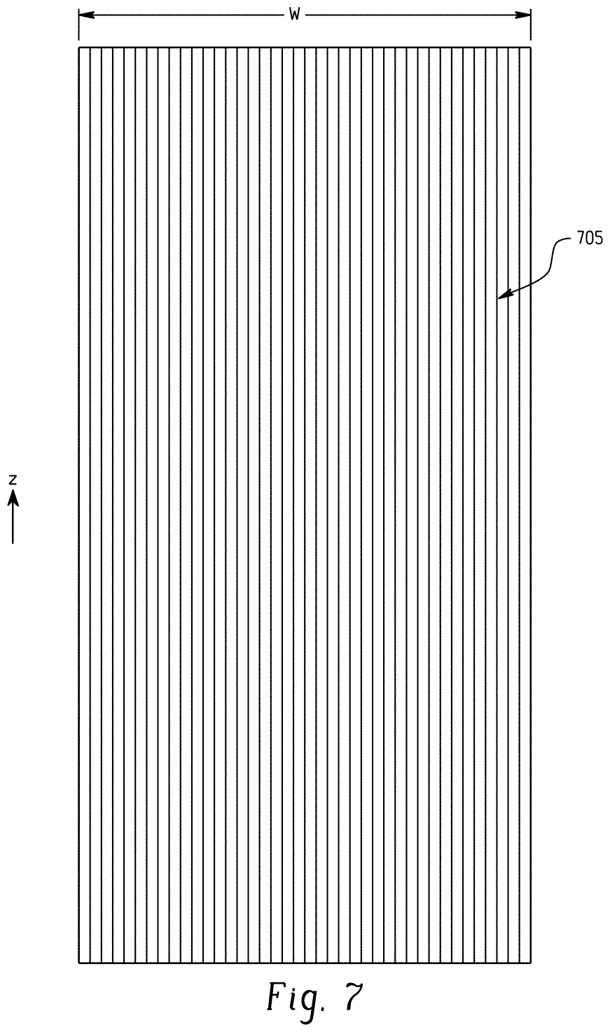

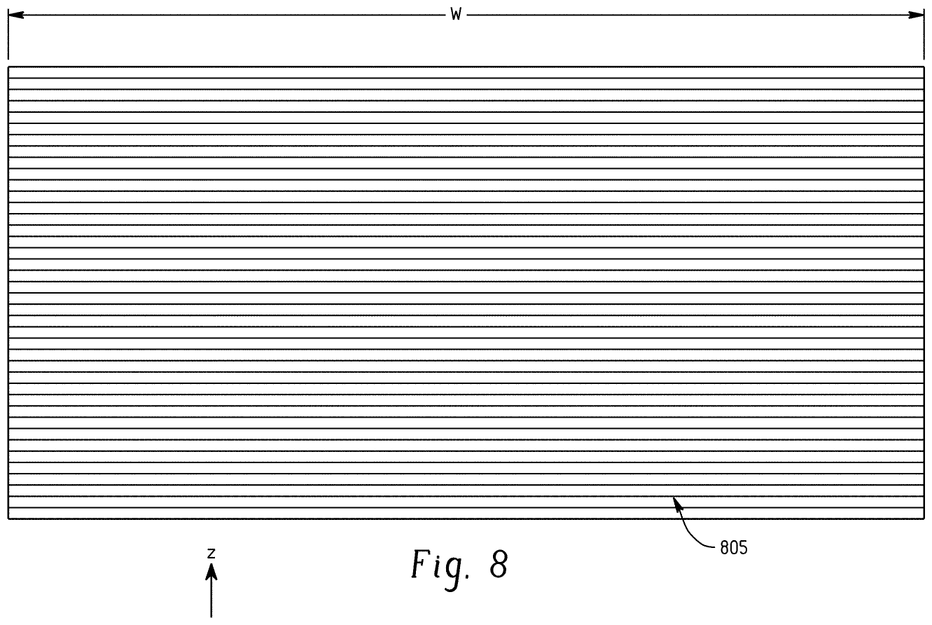

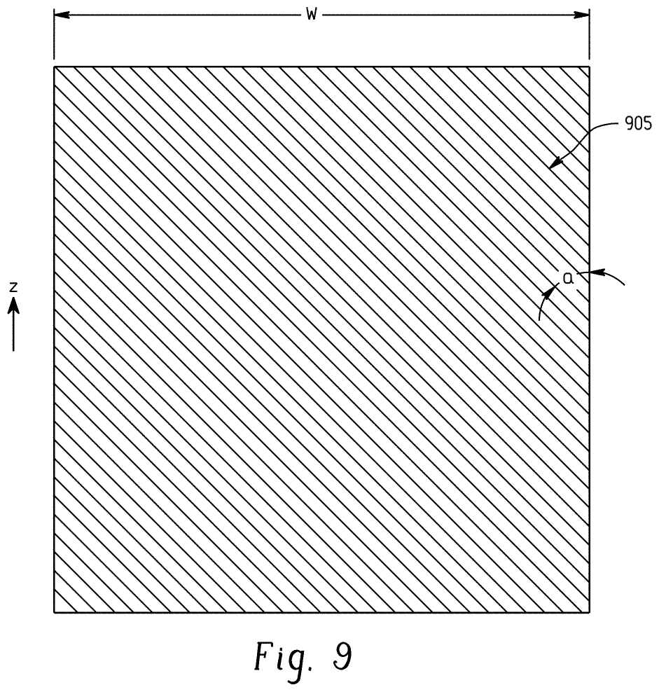

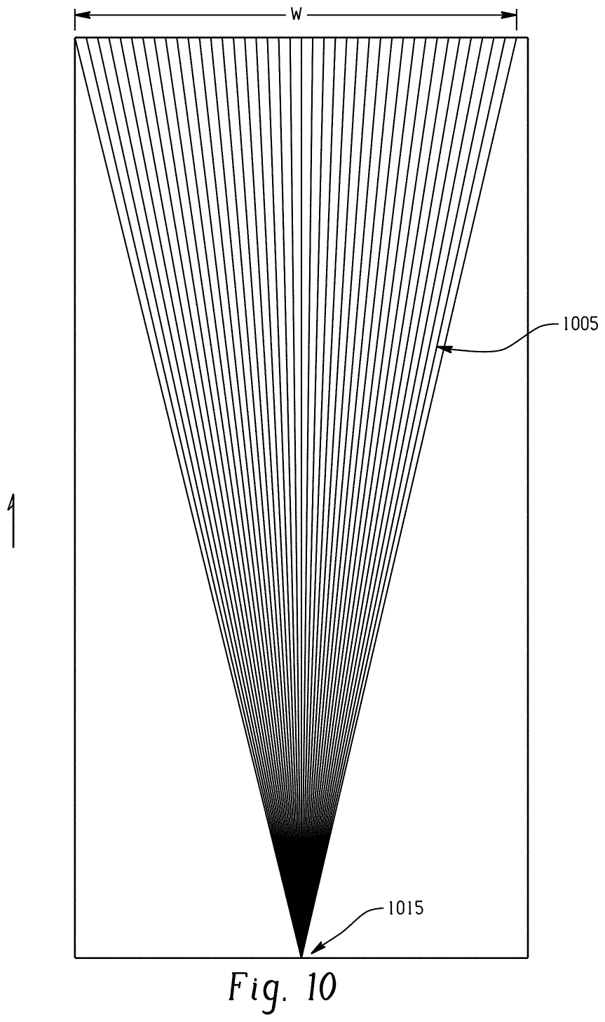

As noted herein above, a scope of the invention is not limited to a plurality of linear cuts 305, 307, 309, 311, but also encompasses a plurality of side by side cuts or scores, which are now described with reference to FIGS. 5-10. In FIG. 5, each of the plurality of side by side cuts or scores 505 is an s-shaped line oriented along the direction of the flutes (z-direction). FIG. 5 also depicts each of the plurality of side by side cuts or scores 505 being an s-shaped line oriented along a direction perpendicular to the flutes (z1-direction), and further depicts each of the plurality of side by side cuts or scores 505 being an s-shaped line oriented along a direction at an angle to the flutes (z2-direction). In FIG. 6, each of the plurality of side by side cuts or scores 605 is an arc-shaped line that traverses the direction of the flutes in a first direction (z-direction). FIG. 6 also depicts each of the plurality of side by side cuts or scores 605 being an arc-shaped line that traverses the direction of the flutes in a second direction (z1-direction), and further depicts each of the plurality of side by side cuts or scores 605 being an arc-shaped line that traverses the direction of the flutes at an angle to the flutes in a third direction (z2-direction). In FIG. 7, each of the plurality of side by side cuts or scores 705 is a linear line oriented parallel to the flutes (z-direction), similar to the plurality of linear cuts 305 depicted in FIG. 2. In FIG. 8, each of the plurality of side by side cuts or scores 805 is a linear line oriented perpendicular to the flutes (z-direction). In FIG. 9, each of the plurality of side by side cuts or scores 905 is a linear line oriented at an angle “a” to the flutes (z-direction). In FIG. 10, each of the plurality of side by side cuts or scores 1005 is a linear line oriented at an angle relative to the flutes (z-direction), wherein the plurality of side by side cuts or scores 1005 have a common point 1015 of intersection at the one side of the at least one curved panel, and fan out to an overall width W at the opposing side of the at least one curved panel.

By varying the shape of the side by side cuts or scores from a linear line to a non-linear line (e.g., s-shaped or arc-shaped), or by varying the orientation of the side by side cuts or scores from being parallel with the flutes, or z-direction, to being non-parallel with the flutes, or z1 or z2-direction (e.g., perpendicular to the flutes, at an angle to the flutes, or in a fanned arrangement relative to the flutes), unexpected advantages were found. For example, it was unexpectedly found that the s-shaped plurality of side by side cuts or scores 505 as depicted in FIG. 5 performed better than any other configuration disclosed herein for forming a smooth outer arced surface, panel 205, of the container 100 for a purpose disclosed herein, for all orientations of the s-shaped plurality of side by side cuts or scores 505 (e.g., relative to the z-direction, z1-direction, or z2-direction). It was also unexpectedly found that the arc-shaped plurality of side by side cuts or scores 605 as depicted in FIG. 6 performed better than the linear plurality of side by side cuts or scores 705 as depicted in FIG. 7, for all orientations of the arc-shaped plurality of side by side cuts or scores 605 (e.g., relative to the z-direction, z1-direction, or z2-direction). It was also unexpectedly found that linear plurality of side by side cuts or scores 805 as depicted in FIG. 8 oriented perpendicular to the z-direction performed acceptably for forming a smooth outer arced surface, panel 205, of the container 100 for a purpose disclosed herein. It was further unexpectedly found that a fan shaped plurality of side by side cuts or scores 1005 performed acceptably for forming a funnel or wave-shaped smooth outer surface of the container 100. It was yet further unexpectedly found that both the s-shaped cuts or scores 505 and the arc-shaped cuts or scores 605, when disposed substantially parallel to the flutes (z-direction), appeared to provide a smooth outer surface, panel 205, of the container 100 that exhibited a stronger resistance to squeeze and/or deformation when exposed to an external load.

While not being held to any particular theory, it is contemplated that both the s-shaped cuts 505 or scores and the arc-shaped cuts or scores 605 perform better than the other configurations of cuts or scores because when run substantially parallel to the flutes (z-direction) there is no opportunity for the cuts or scores to fall between the flutes, and correspondingly no opportunity to produce a false score and create a flat spot, thereby forming a smoother outer arced surface, panel 205, of the container 100.

In an embodiment, the corrugated sheet product material disclosed and used herein is a single wall corrugated sheet product material, not a double wall or triple wall material, and may be a micro-flute, a B-flute, or a C-flute, corrugated sheet product material. However, it has been found that some of the side by side cuts or scores disclosed herein produce a smooth outer arced surface (on panel 205 for example) with micro-flutes, but not as smooth with B-flutes or C-flutes. That said, some degree of undulation on the outer arced surface of panel 205 may be acceptable in some applications using B-flutes or C-flutes. As noted above, the s-shaped plurality of side by side cuts or scores 505 as depicted in FIG. 5 performed better than any other configuration disclosed herein for forming a smooth outer arced surface on panel 205, which was found to be acceptably smooth for micro-flutes, B-flutes, and C-flutes.

In an embodiment, the plurality of side by side cuts or scores, any of which as disclosed herein, extend substantially from one side of the at least one curved panel to substantially an opposing side of the at least one curved panel. As used herein, the phrase “extend substantially from one side of the at least one curved panel to substantially an opposing side of the at least one curved panel” means that the plurality of side by side cuts or scores extend from within about ⅛ inch of an edge of the at least one curved panel to within about ⅛ inch of an opposing edge of the at least one curved panel, as it has been found that the side by side cuts or scores may not necessarily extend all the way to opposing edges of the at least one curved panel in order to produce a desired curvature of the at least one curved panel.

While the planar panels, curved panels, and planar side panels, are disclosed herein having a defined and illustrated geometry, it will be appreciated that this is for illustration purposes only, and is not limiting to the scope of the invention disclosed herein. As such, any geometry for the panels disclosed herein that is commensurate with the appended claims is contemplated and considered to fall within the ambit of the invention disclosed herein.

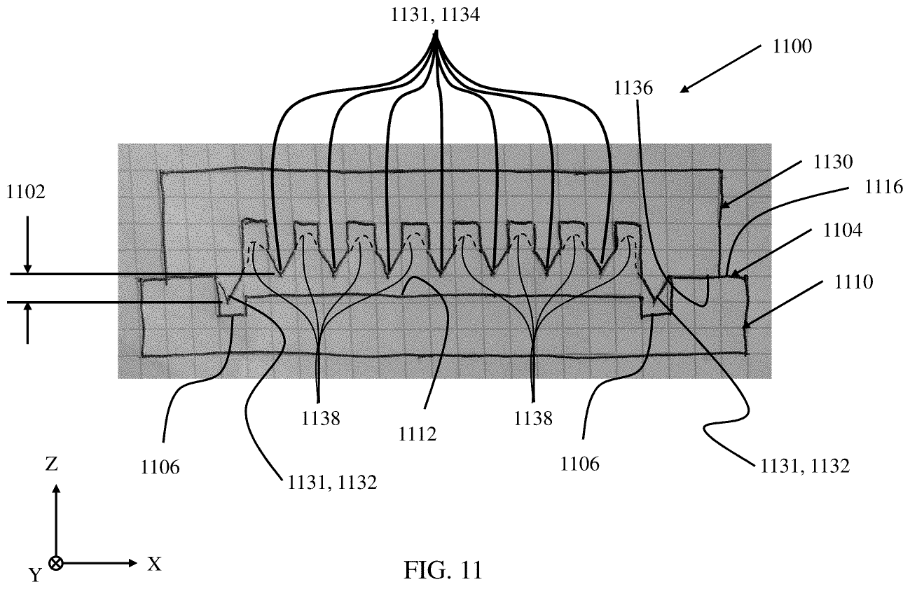

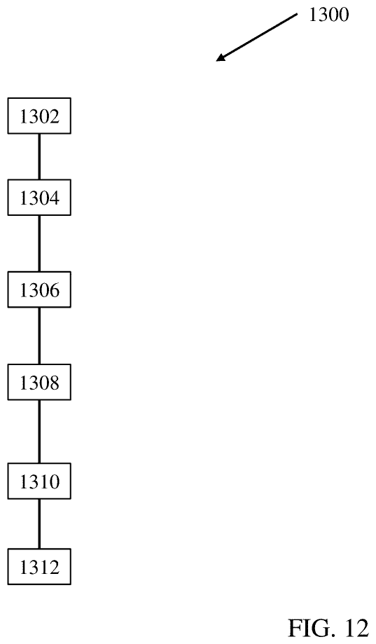

From the foregoing, it will be appreciated that an embodiment disclosed herein is not limited to the fabrication of a curved panel only for use in the form of a container, but also extends to any curved panel for any use that falls within an embodiment of the appended claims. It will also be appreciated from the foregoing that such a curved panel may be formed by a particular cutting tool and a method that uses such a particular cutting tool, which will now be discussed with reference to FIGS. 11-12 in combination with the foregoing figures.

FIG. 11 depicts a block diagram front elevation cross section view of a cutting tool 1100 useful for fabricating a curved panel 205, 207, 209, 211 (generally referred to herein below as curved panel 205). In an embodiment, the cutting tool 1100 is a flatbed cutting tool. In an embodiment, the cutting tool 1100 has a support portion 1110 and a movable cutting portion 1130 that moves vertically (z-direction) relative to the support portion 1110. The cutting portion 1130 has at least one cutting edge 1131 configured to provide at least one first cutting edge 1132, and a plurality of second cutting edges 1134 disposed adjacent each other and at a defined distance relative to each other along the x-axis. Each edge of the plurality of second cutting edges 1134 are recessed in the z-direction relative to an edge of the at least one first cutting edge 1132 by a defined offset dimension 1102. For controlled cutting, the cutting tool 1100 has a stop surface 1104 between engagement surfaces 1116, 1136 of the support portion 1110 and the cutting portion 1130, respectively, and recessed pockets 1106 that extend below a support surface 1112 of the support portion 1110 and into which the at least one first cutting edge 1132 extends when the support portion 1110 and cutting portion 1130 are engaged at the stop surface 1104. In an embodiment, the plurality of second cutting edges 1134 includes a number of the second cutting edges 1134 equal to or greater than 3 and equal to or less than 500. More particularly, the number of the second cutting edges 1134 is equal to or greater than 5 and equal to or less than 100. Even more particularly, the number of the second cutting edges 1134 is equal to or greater than 10 and equal to or less than 30. By comparing FIGS. 11 and 2, it will be appreciated that the at least one first cutting edge 1132 is representative of a cutting edge for producing the outer panel edges of panels 204, 212, and the plurality of second cutting edges 1134 is representative of cutting edges for producing the cuts 305. As used herein, the term flatbed cutting tool means a type of cutting tool or machine that is carried on a horizontal surface.

In an embodiment, the at least one first cutting edge 1132 and the plurality of second cutting edges 1134 may be individual cutting edges separate and distinct from each other. In another embodiment, the at least one first cutting edge 1132 and the plurality of second cutting edges 1134 may be a single continuous cutting edge, depicted by dashed line 1138 and reference numeral 1131 in FIG. 11, constructed in a serpentine, or other suitable, manner with the defined offset dimension 1102 separating edge 1132 from edges 1134. The path of the serpentine single continuous cutting edge 1131, 1138 may follow any path in or out of the plane of FIG. 11 and offset relative to the depicted z-axis in a manner suitable for a purpose disclosed herein. Alternatively, the at least one first cutting edge 1132 and the plurality of second cutting edges 1134 may be any combination of separate and distinct cutting edges and one or more continuous cutting edges. It is also contemplated that the cutting tool 1100 may be constructed with a single cutting edge that is computer controlled to produce the same offset cuts as produced by the at least one first cutting edge 1132 and the plurality of second cutting edges 1134 with the defined offset dimension 1102 therebetween. Any and all such cutting edges suitable for a purpose disclosed herein and falling within an ambit of the appended claims are contemplated herein.

With reference back to and as depicted in FIG. 4, an embodiment of the panel 205 is fabricated from a board or flat blank 200 having an inner side or inner facing, 300, and outer side or outer facing 400, and a corrugated material 500 disposed between the inner facing 300 and the outer facing 400. For purposes of illustration only, the outer facing 400 is herein referred to as an a-layer of the board 200, and the inner facing 300 is herein referred to as a b-layer of the board 200. That said, it will be appreciated that an upside-down representation of the board 200 in FIG. 4 would result in a redefinition of the a-layer and b-layer to be items 300, 400, respectively.

In an embodiment, the defined offset dimension 1102 between each edge of the plurality of second cutting edges 1134 and the edge of the at least one first cutting edge 1132 is no less than a minimum distance that prevents the plurality of second cutting edges 1134 from cutting completely through the b-layer 300 when the board 200 with the b-layer 300 down is placed on the support surface 1112, and when the cutting portion 1130 and the support portion 1110 engage at the stop surface 1104. In an embodiment, the minimum distance is equal to or greater than 20% of a thickness of the b-layer 300 and equal to or less 50% of a caliper thickness of the panel 205. In an embodiment, the minimum distance is a defined distance that prevents the plurality of second cutting edges 1134 from cutting into the b-layer 300 when the cutting portion 1130 and the support portion 1110 engage at the stop surface 1104. In an embodiment, the defined distance is a distance equal to a thickness of the b-layer 300. In an embodiment, the defined offset dimension 1102 between each edge of the plurality of second cutting edges 1134 and the edge of the at least one first cutting edge 1132 is equal to or greater than a thickness of the b-layer 300. In an embodiment, the defined offset dimension 1102 between each edge of the plurality of second cutting edges 1134 and the edge of the at least one first cutting edge 1132 is equal to or greater than 25% of a caliper thickness of the panel 205, and equal to or less than 75% of a caliper thickness of the panel 205. In an embodiment, the defined offset dimension 1102 between each edge of the plurality of second cutting edges 1134 and the edge of the at least one first cutting edge 1132 is equal to about 50% of a caliper thickness of the panel 205. In an embodiment, all edges of the plurality of second cutting edges 1134 are disposed at the defined offset dimension 1102 relative to the at least one first cutting edge 1132.

With reference to FIG. 12 in combination with FIGS. 4 and 11, a method 1300 of forming a board 200 into a curved panel 205, the board 200 comprising a corrugated board having a first facing layer 400, a second facing layer 300, and a corrugated material 500 adhesively joined to and disposed between the first and second facing layers 400, 300, which in an embodiment is a double-faced corrugated board, the method 1300 comprising: providing 1302 and operating the cutting tool 1100 that entails opening or separating 1304 the cutting portion 1130 relative to the support portion 1110 in the positive z-direction; placing 1306 the board 200 to be cut on the support surface 1112 of the support form 1110 such that the b-layer is disposed facing the support portion 1110; moving 1308 in the negative z-direction the cutting portion 1130 toward the support portion 1110 with the board 200 disposed therebetween; further advancing 1310 in the negative z-direction the cutting portion 1130 toward the board 200 such that the at least one first cutting edge 1132 cuts completely through both the a-layer 400 and the b-layer 300 of the board 200, and the plurality of second cutting edges 1134 cut completely through the a-layer 400, but not through the b-layer 300, resulting in the board 200 being an edge cut panel with through cuts in the a-layer 400 and the b-layer 300 at the at least one first cutting edge 1132, and with through cuts in the a-layer 400 but not the b-layer 300 at the plurality of second cutting edges 1134; and, retracting 1312 in the positive z-direction the cutting portion 1130 away from the support portion 1110 and removing the now cut panel 205 to facilitate further manipulation of the panel 205 into the curved panel, via the through cuts in the a-layer 400 but not the b-layer 300 resulting from cuts at the plurality of second cut edges 1134. It is noteworthy to compare the x-y-z coordinate system depicted in FIG. 11 with those depicted in FIGS. 1-10, as it will be appreciated that the z-axis of FIG. 11 is representative of a direction line for up-down movement of the cutting portion 1130 relative to the support portion 1110, while the z-axis of FIGS. 1-10 are representative of a direction line of a stacking load exerted on the curved panel 205 and/or container 100.

In an embodiment where the corrugated material 500 includes flutes with a defined flute direction, the method step of the placing 1306 the panel 205 on the support portion 1110 includes; placing 1306 the panel 205 on the support portion 1110 with the flute direction oriented parallel to a longitudinal direction of the plurality of second cutting edges 1134, or placing 1306 the panel 205 on the support portion 1110 with the flute direction oriented perpendicular to a longitudinal direction of the plurality of second cutting edges 1134, or placing 1306 the panel 205 on the support portion 1110 with the flute direction oriented at an angle to a longitudinal direction of the plurality of second cutting edges 1134.

In an embodiment where the corrugated material 500 includes flutes having a defined flute spacing, the plurality of second cutting edges 1134 are spaced apart, relative to each other, in registration with the defined flute spacing, or alternatively, the plurality of second cutting edges 1134 are spaced apart, relative to each other, out of registration with the defined flute spacing.

In an embodiment, the plurality of second cutting edges 1134 are equidistant to each other (see FIGS. 5-9 for example). In an embodiment, the plurality of second cutting edges 1134 are parallel with each other (see FIGS. 7-9 for example). In an embodiment, each one of the plurality of second cutting edges 1134 are linear (see FIGS. 7-10 for example). In an embodiment, each one of the plurality of second cutting edges 1134 are not linear (see FIGS. 5-6 for example). In an embodiment, each one of the plurality of second cutting edges 1134 are linear and not parallel with each other (see FIGS. 5, 6, 10 for example). In an embodiment, each one of the plurality of second cutting edges 1134 are angularly equidistant with respect to each other (see FIG. 10 for example). In an embodiment, the plurality of second cutting edges 1134 are disposed at a distance between each other that is equal to or less than 0.2 inches and equal to or greater than 0.01 inches.

As used herein, any reference to an absolute structural feature or relationship such as but not limited to parallel, perpendicular, equidistant, or linear, is intended to refer to such structural features or relationships in a non-absolute sense, such as substantially parallel, substantially perpendicular, substantially equidistant, or substantially linear, where the term substantially is intended to cover slight variations from the absolute feature or relationship that does not negate an end result as disclosed herein.

In an embodiment, the cutting tool 1100 comprises a mechanical cutting tool, the at least one first cutting edge 1132 is at least one first knife edge, and the plurality of second cutting edges 1134 is a plurality of a second knife edge.

In an embodiment, the cutting tool 1100 comprises a laser cutting tool; the at least one first cutting edge 1132 is at least one first laser having a power density sufficient to cut through both the a-layer 400 and the b-layer 300; the plurality of second cutting edges 1134 is a plurality of a second laser having a power density sufficient to cut through the a-layer 400, but not through the b-layer 300; the moving 1308 the cutting portion 1130 toward the support portion 1110 includes advancing a power density wave front of the at least one first laser and the plurality of the second laser toward the support portion 1110 in the negative-z direction (with reference to FIG. 11 for example); the further advancing 1310 the cutting portion 1130 toward the board 200 includes further advancing the power density wave front of the at least one first laser and the plurality of the second laser toward the support portion 1110 in the negative-z direction; and, the retracting 1312 the cutting portion 1130 away from the support portion 1110 includes retracting the power density wave front of the at least one first laser and the plurality of the second laser away from support portion 1110 in the positive-z direction.

While an invention has been described herein with reference to example embodiments, it will be understood by those skilled in the art that various changes may be made and equivalents may be substituted for elements thereof without departing from the scope of the claims. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed example embodiments and, although specific terms and/or dimensions may have been employed, they are unless otherwise stated used in a generic, exemplary and/or descriptive sense only and not for purposes of limitation, the scope of the claims therefore not being so limited. In general, the several figures presented herein are not necessarily drawn to scale, and unless otherwise stated should not be interpreted to be so. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item. Additionally, the term “comprising” as used herein does not exclude the possible inclusion of one or more additional features.

What is claimed is:

1. A method of forming a board into a curved panel by strategically cutting the board to strategically weaken it, the board comprising a corrugated board having a first facing layer, a second facing layer, and a corrugated material adhesively joined to and disposed between the first and second facing layers, the method comprising:
providing a cutting tool comprising a support portion and a cutting portion, the cutting portion comprising at least one cutting edge configured to provide at least one first cutting edge, and a plurality of second cutting edges disposed adjacent each other, each edge of the plurality of second cutting edges being recessed relative to an edge of the at least one first cutting edge by a defined offset dimension;
placing the board on the support portion such that a b-layer that is one of the first facing layer or the second facing layer is disposed facing the support portion, and an a-layer that is the other one of the first facing layer or the second facing layer is disposed facing the cutting portion;
moving the cutting portion toward the support portion with the board disposed therebetween;
advancing the cutting portion toward the board such that the at least one first cutting edge cuts completely through both the a-layer and the b-layer of the board, and the plurality of second cutting edges cut completely through the a-layer, but not completely through the b-layer, resulting in the board being an edge cut panel with through cuts in the a-layer and the b-layer at the at least one first cutting edge, and with through cuts in the a-layer but not the b-layer at the plurality of second cutting edges; and
retracting the cutting portion away from the support portion and removing the panel to facilitate further manipulation of the panel into the curved panel via the through cuts in the a-layer but not the b-layer resulting from cuts at the plurality of second cut edges.

2. The method of claim 1, wherein:
the cutting tool is a flatbed cutting tool.

3. The method of claim 1, wherein:
the at least one first cutting edge and the plurality of second cutting edges are separate and distinct from each other.

4. The method of claim 1, wherein:
the at least one first cutting edge and the plurality of second cutting edges are configured as a single continuous cutting edge constructed in a serpentine manner.

5. The method of claim 1, wherein:
the advancing the cutting portion further comprises advancing the cutting portion such that the at least one first cutting edge completely cuts through the corrugated material, and the plurality of second cutting edges at least partially cut through the corrugated material.

6. The method of claim 1, wherein:
the corrugated board comprises a double-faced corrugated board.

7. The method of claim 1, wherein:
the cutting tool comprises a stop surface between the support portion and the cutting portion such that the defined offset dimension between each edge of the plurality of second cutting edges and the edge of the at least one cutting edge is no less than a minimum distance that prevents the plurality of second cutting edges from cutting completely through the b-layer when the cutting portion and the support portion engage at the stop surface.

8. The method of claim 7, wherein:
the minimum distance is equal to or greater than 20% of a thickness of the b-layer and equal to or less 50% of a caliper thickness of the panel.

9. The method of claim 7, wherein:
the minimum distance is a defined distance that prevents the plurality of second cutting edges from cutting into the b-layer when the cutting portion and the support portion engage at the stop surface.

10. The method of claim 9, wherein:
the defined distance is a distance equal to a thickness of the b-layer.

11. The method of claim 1, wherein:
the defined offset dimension between each edge of the plurality of second cutting edges and the edge of the at least one cutting edge is equal to or greater than a thickness of the b-layer.

12. The method of claim 1, wherein:
the defined offset dimension between each edge of the plurality of second cutting edges and the edge of the at least one cutting edge is equal to or greater than 25% of a caliper thickness of the panel, and equal to or less than 75% of a caliper thickness of the panel.

13. The method of claim 1, wherein:
the defined offset dimension between each edge of the plurality of second cutting edges and the edge of the at least one cutting edge is equal to about 50% of a caliper thickness of the panel.

14. The method of claim 1, wherein:
the corrugated board of the panel excludes a double-wall corrugated board.

15. The method of claim 1, wherein:
the plurality of second cutting edges are equidistant to each other.

16. The method of claim 15, wherein:
the plurality of second cutting edges are parallel with each other.

17. The method of claim 15, wherein:
each one of the plurality of second cutting edges are linear.

18. The method of claim 15, wherein:
each one of the plurality of second cutting edges are not linear.

19. The method of claim 1, wherein:
each one of the plurality of second cutting edges are linear and not parallel with each other.

20. The method of claim 19, wherein:
each one of the plurality of second cutting edges are angularly equidistant with respect to each other.

21. The method of claim 1, wherein:
the plurality of second cutting edges are disposed at a distance between each other that is equal to or less than 0.2 inches and equal to or greater than 0.01 inches.

22. The method of claim 1, wherein the corrugated material comprises flutes having a defined flute direction, and further wherein:
the placing the panel on the support portion comprises placing the panel on the support portion with the flute direction oriented parallel to a longitudinal direction of the plurality of second cutting edges.

23. The method of claim 1, wherein the corrugated material comprises flutes having a defined flute direction, and further wherein:
the placing the panel on the support portion comprises placing the panel on the support portion with the flute direction oriented perpendicular to a longitudinal direction of the plurality of second cutting edges.

24. The method of claim 1, wherein the corrugated material comprises flutes having a defined flute direction, and further wherein:
the placing the panel on the support portion comprises placing the panel on the support portion with the flute direction oriented at an angle to a longitudinal direction of the plurality of second cutting edges.

25. The method of claim 1, wherein the corrugated material comprises flutes having a defined flute spacing, and further wherein:
the plurality of second cutting edges are spaced apart, relative to each other, in registration with the defined flute spacing.

26. The method of claim 1, wherein the corrugated material comprises flutes having a defined flute spacing, and further wherein:
the plurality of second cutting edges are spaced apart, relative to each other, out of registration with the defined flute spacing.

27. The method of claim 1, wherein:
the plurality of second cutting edges comprises a number of the second cutting edges equal to or greater than 3 and equal to or less than 500.

28. The method of claim 27, wherein:
the number of the second cutting edges is equal to or greater than 10 and equal to or less than 30.

29. The method of claim 1, wherein;
the cutting tool comprises a mechanical cutting tool;
the at least one first cutting edge is at least one first knife edge;
the plurality of second cutting edges is a plurality of a second knife edge.

30. The method of claim 1, wherein:
the cutting tool comprises a laser cutting tool;
the at least one first cutting edge is at least one first laser having a power density sufficient to cut through both the a-layer and the b-layer;
the plurality of second cutting edges is a plurality of a second laser having a power density sufficient to cut through the a-layer, but not through the b-layer;
the moving the cutting portion toward the support portion comprises advancing a power density wave front of the at least one first laser and the plurality of the second laser toward the support portion;
the advancing the cutting portion toward the board comprises further advancing the power density wave front of the at least one first laser and the plurality of the second laser toward the support portion;
the retracting the cutting portion away from the support portion comprises retracting the power density wave front of the at least one first laser and the plurality of the second laser away from support portion.
